(19) United States
(12) Patent Application Publication
(10) Pub. No.: US 2011/0313601 A1
(43) Pub. Date: Dec. 22, 2011

(54) METHOD FOR DETERMINING THE ACTUAL STATE OF A HYBRID DRIVE TRAIN

(76) Inventors: Johannes Kaltenbach, Friedrichshafen (DE); Stefan Wallner, Mattsee (AT)

(21) Appl. No.: 12/743,773

(22) PCT Filed: Oct. 22, 2008
(86) PCT No.: PCT/EP08/64234

§ 371 Date: Nov. 4, 2010

(30) Foreign Application Priority Data
Nov. 20, 2007 (DE) 102007047818.8

(51) Int. Cl. B60W 20/00

(52) U.S. Cl. 701/22; 180/65.25; 903/902

(57) ABSTRACT

Within the scope of the method for determining the actual state of a hybrid drive train of a parallel hybrid vehicle as information for the hybrid operating strategy or the strategic layer of the hybrid control, an abstract strategy actual state is formed, on the basis of the actual state of the hybrid drive train, as information for the hybrid operating strategy or the strategic layer of the hybrid control, wherein each actual state of the hybrid drive train is unambiguously assigned to a strategy actual state.

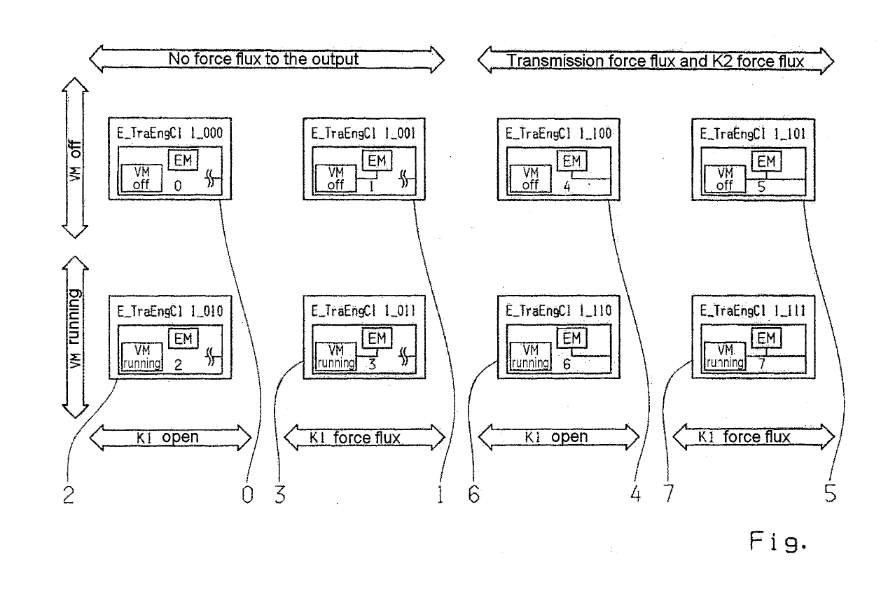

The present invention relates to a method for determining the actual state of a hybrid drive train of a parallel hybrid vehicle as information for the hybrid operating strategy or the strategic layer of the hybrid control according to the preamble of patent claim 1.

Hybrid vehicles comprising a hybrid transmission are known from the prior art. They comprise at least one electric motor or an electric machine in addition to the internal combustion engine. In serial hybrid vehicles, a generator is driven by the internal combustion engine, wherein the generator supplies electrical energy to the electric motor which drives the wheels. Furthermore, parallel hybrid vehicles are known in which the torques of the internal combustion engine and of at least one electric machine which can be connected to the internal combustion engine are added. In this context, the electric machines can be connected to the belt drive or to the crankshaft of the internal combustion engine. The torques which are generated by the internal combustion engine and/or the at least one electric machine are transmitted to the driven axle via a transmission which is connected downstream.

The object of a hybrid operating strategy in hybrid vehicles is to predefine an operating mode and to distribute the driver's requested torque or the driver's requested power to the internal combustion engine and to the at least one electric machine when the internal combustion engine and electric machine are operatively connected and/or when all the clutches in hybrid systems with an integrated starter/generator are sticking.

The prior art has disclosed hybrid vehicles which have a hybrid control which is divided into at least two function layers, with the one layer (strategic layer) comprising the strategic functions or quasi-steady-state prescriptions in terms of states and continual variables, and the second layer (operative layer) comprising the operative functions or dynamic transitions.

It is important in this context that the actual state of the hybrid drive train of the vehicle is present as abstract information for the strategy. According to the prior art, the strategy or the strategic layer has separate determination of the actual state, in which case it is disadvantageously possible that the actual state which is determined by means of this actual state determination does not correspond to the drive train actual state of the operative layer (control level) so that switching times are difficult to coordinate.

The present invention is based on the object of specifying a method for determining the actual state of a hybrid drive train of a parallel hybrid vehicle as information for the hybrid operating strategy or the strategic layer of the hybrid control, by means of whose implementation the actual state of the hybrid drive train is easily correctly modeled.

This object is achieved by means of the features of patent claim 1. Further inventive refinements and advantages emerge from the dependent claims.

It is accordingly proposed that an abstract strategy actual state is formed, on the basis of the actual state of the hybrid drive train, as information for the hybrid operating strategy or the strategic layer of the hybrid control, wherein each actual state of the hybrid drive train is unambiguously assigned to a strategy actual state.

In this context, the information for the strategy is abstracted in the formed strategy actual state within the scope of the method according to the invention so that the number of formed strategy actual states is lower than the number of actual states of the hybrid drive train.

For example, in a hybrid vehicle comprising an internal combustion engine and at least one electric machine which are connected in series in this sequence, wherein the internal combustion engine can be decoupled from the electric machine and therefore from the drive train by opening a clutch K1 and wherein by means of a second optional clutch K2 the transmission input can be detachably connected to the output of the electric machine or of a summing gear in which the torques of the electric machine and of the internal combustion engine are summed, the strategy actual states of “electric travel—internal combustion engine off”, “electric travel—internal combustion engine on”, “hybrid travel” and “charging” are formed from the possible actual states of the hybrid drive train. If a clutch K2 is not provided, the force flux to the output is determined solely by the transmission (gear speed engaged/neutral position).

In the text which follows, an exemplary refinement of the method according to the invention is explained on the basis of the appended figure which represents the possible actual states of a hybrid drive train comprising a clutch K1 and a clutch K2. If no clutch K2 is provided between the electric machine and the transmission, the electric machine is permanently connected to the transmission.

The figure illustrates the possible actual states of a hybrid drive train of a parallel hybrid vehicle comprising an internal combustion engine VM and at least one electric machine EM which are connected in series in this sequence, wherein the internal combustion engine can be decoupled from the electric machine and therefore from the drive train by opening a clutch K1 and wherein by means of a second clutch K2 the transmission input can be detachably connected to the output of the electric machine or of a summing gear in which the torques of the electric machine and of the internal combustion engine are summed.

In the figure, 0 denotes the actual state of the hybrid drive train in which both clutches K1 and K2 are open when the internal combustion engine is switched off so that no force flux to the output or to the transmission input is present, wherein the internal combustion engine is decoupled from the electric machine or the drive train, and wherein the state in which the clutch K1 is closed and the clutch K2 is open when the internal combustion engine is switched off (internal combustion engine is connected to the electric machine with the force flux to the output or to the transmission input being interrupted) is denoted by 1.

In addition, in the figure, 4 denotes the state in which the clutch K1 is open and the clutch K2 is closed when the internal combustion engine is switched off; 5 denotes the state in which the clutches K1 and K2 are closed when the internal combustion engine is switched off. 2 denotes the state in which both clutches K1 and K2 are open when the internal combustion engine is started so that no force flux to the output or to the transmission input is present, with 3 denoting the state in which the clutch K1 is closed and the clutch K2 is open when the internal combustion engine is started, with the result that the internal combustion engine is connected to the electric machine, with the force flux to the output or to the transmission input being interrupted; in this state the electric machine is charged by means of the internal combustion engine. The transmission can have the “neutral” gearshift position. If no clutch K2 is provided, the transmission has the “neutral” gearshift position.

In the state denoted by 6, the clutch K1 is open and the clutch K2 is closed when the internal combustion engine is started, with the result that the transmission input is connected to the electric machine, wherein the internal combustion engine is decoupled from the electric machine or from the drive train; furthermore, 7 denotes the state of the hybrid drive train in which the clutches K1 and K2 are closed when the internal combustion engine is started, with the result that the internal combustion engine is connected to the drive train and the force flux to the transmission input is not interrupted. In this state, a gear speed is engaged in the transmission.

The strategy actual states of “electric travel—internal combustion engine off”, “electric travel—internal combustion engine on”, “hybrid travel” and “charging” are formed from the possible actual states of the hybrid drive train, wherein the actual states of the hybrid drive train 0, 1, 4 and 5 are assigned the strategy actual state of “electric travel—internal combustion engine off”, and the actual states of the hybrid drive train 2, 6 are assigned the strategy actual state of “electric travel—internal combustion engine on”. In addition, the actual state of the hybrid drive train 7 is assigned the strategy actual state of “hybrid travel”, and the actual state of the hybrid drive train 3 is assigned the strategy actual state of “charging”.

The switching time in the case of changes of state of the drive train actual state and of the strategy actual state is always the same here.

As a result of the conception according to the invention, a method is made available for determining the actual state of a hybrid drive train of a parallel hybrid vehicle as information for the hybrid operating strategy or the strategic layer of the hybrid control whose execution does not require a complex function or a state graph.

Furthermore, in the strategy actual state formed according to the invention the information for the strategy is abstracted, with the result that less detailed knowledge about the structure of the drive train is necessary at the strategy level.

1. A method for determining the actual state of a hybrid drive train of a parallel hybrid vehicle as information for the hybrid operating strategy or the strategic layer of the hybrid control, characterized in that an abstract strategy actual state is formed, on the basis of the actual state of the hybrid drive train, as information for the hybrid operating strategy or the strategic layer of the hybrid control, wherein each actual state of the hybrid drive train is unambiguously assigned to a strategy actual state.

2. The method for determining the actual state of a hybrid drive train of a parallel hybrid vehicle as information for the hybrid operating strategy or the strategic layer of the hybrid control, as claimed in claim 1, characterized in that in a hybrid vehicle comprising an internal combustion engine and at least one electric machine which are connected in series in this sequence, wherein the internal combustion engine can be decoupled from the electric machine and therefore from the drive train by opening a clutch K1 and wherein by means of a second optional clutch K2 the transmission input can be detachably connected to the output of the electric machine or of a summing gear in which the torques of the electric machine and of the internal combustion engine are summed, the strategy actual states of “electric travel—internal combustion engine off”, “electric travel—internal combustion engine on”, “hybrid travel” and “charging” are formed from the actual states of the hybrid drive train.

3. The method for determining the actual state of a hybrid drive train of a parallel hybrid vehicle as information for the hybrid operating strategy or the strategic layer of the hybrid control, as claimed in claim 2, characterized in that the actual states of the hybrid drive train in which the internal combustion engine is switched off are assigned the strategy actual state of “electric travel—internal combustion engine off”, in that the actual states of the hybrid drive train in which the internal combustion engine is started and is decoupled from the drive train are assigned the strategy actual state of “electric travel—internal combustion engine on”, in that the actual state of the hybrid drive train in which the internal combustion engine is started and is connected to the drive train, wherein the optional coupling K2 is closed and a gear speed is engaged in the transmission, is assigned the strategy actual state of “hybrid travel”, and in that the actual state of the hybrid drive train in which the clutch K1 is closed with the internal combustion engine started and the optional clutch K2 is open and/or the transmission is in the “neutral” gearshift position is assigned the strategy actual state of “charging”.
